(19) United States
(12) Patent Application Publication
(10) Pub. No.: US 2006/0290735 A1
(43) Pub. Date: Dec. 28, 2006

(54) Inkjet printhead, inkjet image forming apparatus including the same, and method for performing maintenance operations in inkjet image forming apparatus

(75) Inventor: Si-Joong Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/358,409

(22) Filed: Feb. 22, 2006

(30) Foreign Application Priority Data
Jun. 23, 2005 (KR) 10-2005-0054378

(51) Int. Cl. B41J 29/393

(52) U.S. Cl. 347/19; 347/86

(57) ABSTRACT

An inkjet printhead that enables a controller to determine whether or not refilled ink is qualified ink, an inkjet image forming apparatus that includes the inkjet printhead and a controller for controlling the operation of the printhead, and a method for performing maintenance operations in an inkjet image forming apparatus according to whether refilled ink is qualified ink or not are provided. The printhead includes an ink tank for storing ink, a plurality of nozzles for forming an image on a printing medium by ejecting the ink stored in the ink tank to the printing medium, and a memory for storing identity information for determining whether the ink stored in the ink tank is qualified ink or not. The controller determines whether the ink stored in the ink tank is qualified ink based on the identity information and controls the inkjet printhead to perform maintenance operations according to a mode for qualified ink or non-qualified ink based on the result of the determination.

### CROSS-REFERENCE TO RELATED PATENT APPLICATIONS

This application claims the benefit under 35 U.S.C. §119(a) of Korean Patent Application No. 10-2005-0054378, filed on Jun. 23, 2005, in the Korean Intellectual Property Office, the entire disclosure of which is hereby incorporated by reference.

### BACKGROUND OF THE INVENTION

1. Field of the Invention

The present invention relates to an inkjet image forming apparatus. More particularly, the present invention relates to an inkjet image forming apparatus that performs maintenance operations according to whether or not refilled ink is qualified ink.

2. Description of the Related Art

An inkjet image forming apparatus prints images by using a printhead to eject ink droplets onto a paper sheet. The inkjet image forming apparatus may include a shuttle-type printhead that ejects ink droplets while reciprocally traveling in the width direction of paper or an array type printhead that includes a nozzle unit that is longer than the width of paper.

Ink must be periodically refilled in the inkjet image forming apparatus. Preferably, qualified ink (that is, ink certified by the manufacturer of the inkjet image forming apparatus) is used to ensure the print quality and life span of the image forming apparatus. Non-qualified ink, or ‘reclaimed ink’,is occasionally used, however. In general, non-qualified ink is thinner and more volatile than qualified ink, so that non-qualified ink dries faster.

Meanwhile, an inkjet image forming apparatus performs maintenance operations during standby times (that is, when printing is not performed), such that ink ejection is performed in optimal conditions. The maintenance operations may include, for example, a spitting operation or a wiping operation. In a spitting operation, a small amount of ink is sprayed out of inkjet printhead to prevent nozzles from clogging with dried ink particles. In a wiping operation, ink drops around the nozzles are wiped off to prevent deviation of an ink ejection direction.

Conventional inkjet image forming apparatuses are designed to perform maintenance operations which are suitable for qualified ink. Thus, when non-qualified ink is used, the print quality and life span of the inkjet image forming apparatus cannot be ensured.

Accordingly, there is a need for an inkjet image forming apparatus that ensures the print quality and life span of the inkjet image forming apparatus regardless of whether qualified or non-qualified ink is used.

### SUMMARY OF THE INVENTION

An aspect of the present invention is to address at least the above problems and/or disadvantages and to provide at least the advantages described below. Accordingly, an aspect of the present invention is to provide an inkjet printhead that determines whether refilled ink is qualified ink, an inkjet image forming apparatus that includes the inkjet printhead, and a method for performing maintenance operations in the inkjet image forming apparatus according to whether or not refilled ink is qualified. The inkjet printhead may be an array type printhead.

The present invention also provides an inkjet printhead that ejects ink droplets to a printing medium to form an image, and an inkjet image forming apparatus that includes the inkjet printhead and a controller that controls the inkjet printhead.

According to an aspect of the present invention, an inkjet image forming apparatus is provided. The inkjet f6rming apparatus comprises an inkjet printhead that forms an image on a printing medium by ejecting ink to the printing medium, and a controller that controls an operation of the inkjet printhead. The inkjet printhead comprises an ink tank for storing ink, a plurality of nozzles for forming an image on the printing medium by ejecting the ink stored in the ink tank onto the printing medium, and a memory for storing identity information for determining whether the ink stored in the ink tank is a qualified ink or not. The controller determines whether the ink stored in the ink tank is qualified ink based on the identity information and controls the inkjet printhead to perform maintenance operations according to a mode for qualified ink or non-qualified ink based on the result of the determination.

The inkjet printhead may be an array type inkjet printhead.

The identity information stored in the memory may be a certification code of a printer manufacturer, the memory may be attached to the ink tank such that the memory can be replaced by a new one when the ink tank is replaced, and the controller may be designed to determine that the ink stored in the memory is non-qualified ink when the identity information stored in the memory is not a proper certification code.

The inkjet printhead may further comprise a sensor for measuring the amount of ink remaining in the ink tank.

The identity information stored in the memory may be set to an initial value each time that ink is refilled and may be a dot count number obtained by counting a total number of ink dots ejected from the nozzles. The controller may be designed to compare the amount of remaining ink calculated based on a signal of the sensor with the amount of remaining ink calculated based on the dot count number stored in the memory. The controller determines that the ink stored in the ink tank is a non-qualified ink when a difference between the calculated amounts of remaining ink is greater than a predetermined reference value.

The maintenance operations may include spitting a small amount of ink from the nozzles during a standby time, and the controller may control the inkjet printhead such that a spitting cycle according to the mode for non-qualified ink is shorter than a spitting cycle according to the mode for qualified ink.

The maintenance operations may include spitting a small amount of ink from the nozzles during a standby time, and the controller may control the inkjet printhead such that the amount of ink ejected during a single spitting according to the mode for non-qualified ink is larger than according to the mode for qualified ink.

The maintenance operations may include spitting a small amount of ink from the nozzles during a standby time, and the controller may control the inkjet printhead such that the amount of ink ejected during a single spitting according to the mode for non-qualified ink is larger than according to the mode for qualified ink.

According to another aspect of the present invention, a method for performing maintenance operations in an inkjet image forming apparatus is provided. The method comprises the steps of determining whether or not ink stored in an ink tank is a qualified ink based on identity information stored in a memory formed on an inkjet printhead, and selecting a maintenance mode and performing the maintenance operations according to a mode for qualified ink when the ink stored in the ink tank is determined as qualified ink or according to a mode for non-qualified ink when the ink stored in the ink tank is determined as non-qualified ink.

The identity information stored in the memory may be a certification code of a printer manufacturer, and in the step of determining whether or not ink stored in an ink tank is a qualified ink, the ink stored in the ink tank may be determined as being non-qualified ink when the identity information stored in the memory is not a proper certification code

The identity information may be set to an initial value each time that the ink is refilled and a dot count number may be obtained by counting the total number of ink dots ejected from the nozzles. In the step of determining whether or not ink stored in an ink tank is a qualified ink, the amount of remaining ink is calculated based on a signal of a sensor (which is formed on an inkjet printhead) for measuring the amount of remaining ink and the amount of remaining ink is calculated based on the dot count number stored in the memory. The results may be compared and when a difference between the calculated amounts of remaining ink is greater than a predetermined reference value, the ink stored in the ink tank may be determined as being non-qualified ink.

In the step of selecting the maintenance mode and performing maintenance operations, the maintenance operations may include spitting a small amount of ink from the nozzles during a standby time. The spitting may be performed such that a spitting cycle according to the mode for non-qualified ink is shorter than a spitting cycle according to the mode for qualified ink.

In the step of selecting the maintenance mode and performing maintenance operations, the maintenance operations may include spitting a small amount of ink from the nozzles during a standby time. The spitting may be performed such that the amount of ink ejected during a single spitting according to the mode for non-qualified ink is larger than according to the mode for qualified ink.

In the step of selecting the maintenance mode and performing maintenance operations, the maintenance operations may include wiping ink drops around the nozzles during a standby time. The wiping may be performed such that a wiping cycle according to the mode for non-qualified ink is shorter than a wiping cycle according to the mode for qualified ink.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a cross-sectional view of an inkjet image forming apparatus according to an exemplary embodiment of the present invention;

FIG. 2 is a perspective view of the array type printhead shown in FIG. 1;

FIG. 3 is a block diagram of a controller included in the inkjet image forming apparatus of FIG. 1;

FIG. 4 is a view of a wiping operation of the maintenance operations of the inkjet image forming apparatus of FIG. 1; and

FIG. 5 is a view of a spitting operation of the maintenance operations of the inkjet image forming apparatus of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

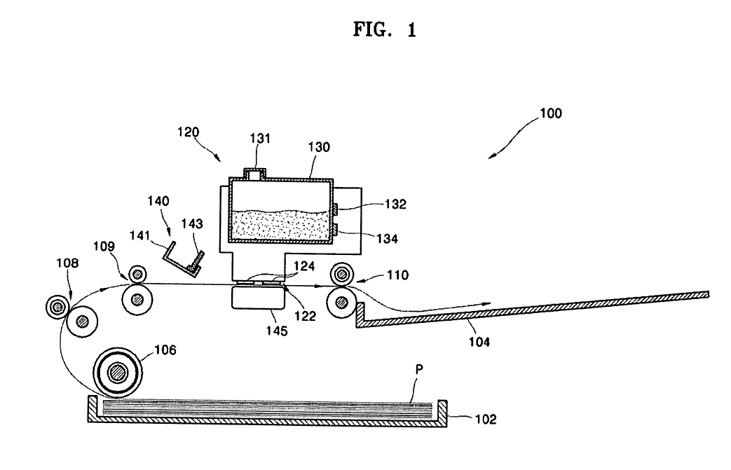

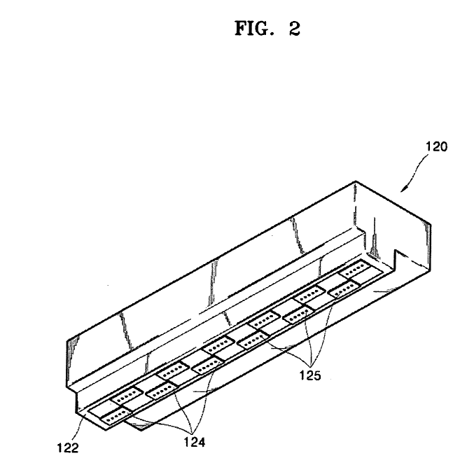

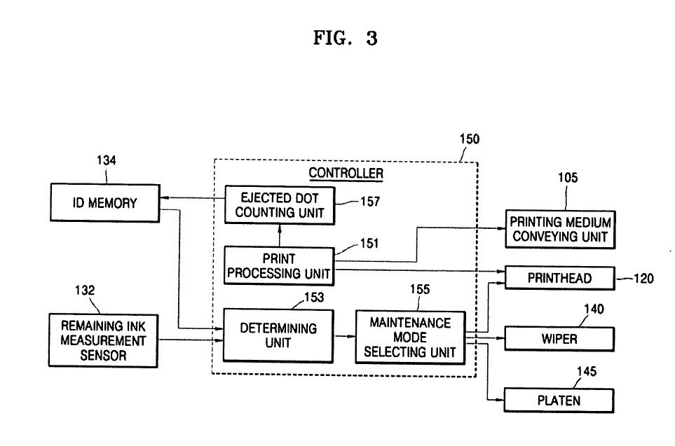

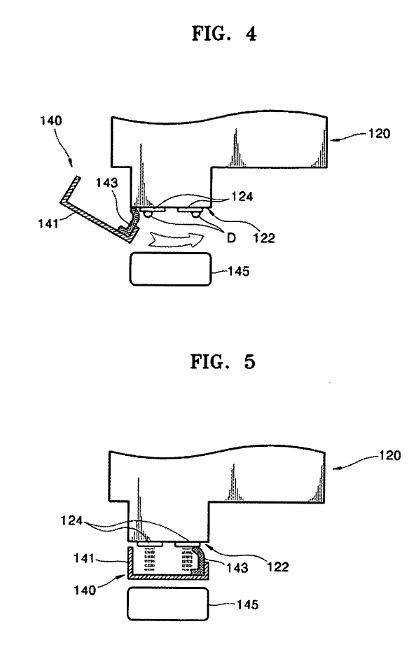

FIG. 1 is a cross-sectional view of an image forming apparatus 100 according to an exemplary embodiment of the present invention. FIG. 2 is a perspective view of an array type printhead 120 of the image forming apparatus 100 of FIG. 1. FIG. 3 is a block diagram of a controller 150 of the image forming apparatus of FIG. 1. FIG. 4 is a view of a wiping operation, which is one of maintenance operations performed by the image forming apparatus of FIG. 1. FIG. 5 is a view of a spitting operation, which is one of maintenance operations performed by the image forming apparatus of FIG. 1.

Referring to FIGS. 1 and 2, the image forming apparatus 100 includes a feeding tray 102 in which printing media P are stacked, and a discharge tray 104 on which a discharged printing medium P, on which an image has been printed, is stacked. A printing medium conveying unit 105 (shown in FIG. 3) conveys the printing media sheet by sheet from the feeding tray 102 to the discharge tray 104 along a predetermined transfer path. The printhead 120 (which is an array type inkjet printhead in the illustrated exemplary embodiment) prints an image on the printing medium P conveyed along the transfer path by ejecting ink droplets to the printing medium P.

The printing medium conveying unit 105 includes a pickup roller 106 that picks up the printing media P sheet by sheet from the feeding tray 102. A first feed roller 108 and a second feed roller 109 align and feed the picked up printing medium P to pass below the printhead 120. A discharge roller 110 discharges the printing medium P on which an image has been printed by ejecting ink onto the printing medium P.

The printhead 120 includes an ink tank 130 that stores ink. A plurality of nozzles 125 to eject ink are formed on a nozzle surface 122 on the bottom of the printhead 120. The nozzle surface 122 extend in the width direction of the printing medium P as shown in FIG. 2, and a plurality of nozzle chips 124, are alternately arranged on the nozzle surface 122 in the length direction of the nozzle surface 122. A predetermined number of nozzles 125 are formed on the nozzle chips 124. When printing an image, the printhead 120 does not need to move in the width direction of the printing medium P, and can print an image on a line basis because ink is simultaneously ejected from some nozzles selected from the nozzles 125 on the nozzle surface 122.

When the ink stored in the ink tank 130 is exhausted, a cap 131 is opened and ink is refilled in the ink tank 130. The ink stored in the ink tank 130 is guided to the nozzle chips 124.

The printhead 120 includes an identity (ID) memory 134 that stores ID information for detecting whether the ink stored in the ink tank 130 is qualified ink. The ID memory 134 may be formed by a non-volatile memory chip such that the stored information is not erased when power supply is cut off, and may be fixed to the ink tank 130. The ID information stored in the memory 134 may be a dot count number obtained by counting the total number of ink dots ejected by the nozzles 125 to print an image.

The printhead 120 may further include a sensor 132 for directly measuring the amount of ink remaining in the ink tank 130. The ID memory 134 and the sensor 132 are electrically connected to a controller 150 (refer to FIG. 3), which will be described later, in order to transmit and receive a signal therebetween.

The inkjet image forming apparatus 100 includes a platen 145 disposed below the nozzle surface 122. The platen 145 prevents defective printing by maintaining a constant distance between the printing medium P and the nozzle surface 122 during printing.

The operation of the inkjet image forming apparatus 100 is as follows. Printing media P is picked up sheet by sheet from the feeding tray 102 by the pickup roller 106, starting from the uppermost printing media P. The picked up sheets are fed to the first and second feed rollers 108 and 109 and then pass below the printhead 120. While passing below the printhead 120, the nozzles 125 of the printhead 120 eject ink to the printing medium P to print an image on the printing medium P. The printing medium P on which the image has been printed is discharged by the discharge roller 110 and then stacked on the discharge tray 104.

The inkjet image forming apparatus 100 performs maintenance operations during a standby time (that is, when printing operations are not being performed), to prevent degradation of print quality. The maintenance operations include, for example, a spitting operation and a wiping operation. In a spitting operation, a little amount of ink is ejected to prevent the nozzles 125 from clogging with dried ink particles. In a wiping operation, ink drops around the nozzles 125 are wiped off to prevent deviation of an ink ejection direction.

The inkjet image forming apparatus 100 includes a wiper 140 for the maintenance operations. The wiper 140 includes a tray 141 and a cleaning member 143. The tray 141 has a length corresponding to the length of the nozzle surface 122, and extends to cover the nozzle surface 122. A cleaning member 143 is made of rubber.

Referring to FIG. 3, the inkjet image forming apparatus 100 (referring to FIG. 1) includes a controller 150 that controls the printing operation and the maintenance operations. The controller 150 is electrically connected to the printing medium conveying unit 105, the printhead 120, the wiper 140, and the platen 145, and transmits a control signal to control them. Also, the controller 150 is electrically connected to the ID memory 134 and the sensor 132 to determine whether ink is stored in the ink tank 130 (refer to FIG. 1).

The controller 150 includes a print processing unit 151 that controls the printing operation performed by a printing command. The print processing unit 151 controls the printing medium conveying unit 105 to convey the printing medium P (referring to FIG. 1) and controls the printhead 120 to eject ink to the printing medium P.

Further, the controller 150 includes a determining unit 153 that determines whether the ink stored in the ink tank 130 is qualified ink based on the ID information stored in the ID memory 134 and a measurement signal of the sensor 132. The controller 150 also includes a maintenance mode selecting unit 155 that selects a maintenance mode for qualified ink or non-qualified ink according to the result of the determining unit 130. The controller 150 controls the printhead 120, the wiper 140, and the platen 145 to perform the maintenance operations according to the selection made by the maintenance mode selecting unit 155. The controller 150 further includes an ejected dot counting unit 157 that counts the number of ink dots ejected by the nozzles 125 (refer to FIG. 2) during printing and adds the counted number of ink dots to the dot count number stored in the ID memory 134 to update the dot count number.

The operation of the controller 150 and a method of performing maintenance operations in the inkjet image forming apparatus 100 using the controller 150 will now be described.

A user should refill the ink tank 130 when ink in the ink tank 130 is exhausted. When the ink tank 130 is refilled with qualified ink, a service provider resets the dot count number stored in the ID memory 134 to an initial value as well as refills the ink tank 130 with qualified ink. For example, the service provider may fully refill the ink tank 130 with qualified ink and set the dot count number to 0.

When the power supply is turned on after refilling the ink tank 130, the determining unit 153 of the controller 150 receives a measurement signal, which is obtained by measuring the amount of ink remaining in the ink tank 130, from the sensor 132, and calculates the amount R1 of ink remaining in the ink tank 130 based on the measurement signal. Further, the determining unit 153 calculates the amount R2 of ink remaining in the ink tank 130 based on the dot count number received from the ID memory 134. If the tank is refilled with qualified ink, because the dot count number is reset to 0 in the ID memory 134, there is a small difference between R1 and R2. However, if the tank is refilled with non-qualified ink, since the dot count number in the ID memory is not reset, there is a large difference between R1 and R2. When a difference between R1 and R2 is greater than a predetermined reference value, the determining unit 153 determines that the ink in the ink tank 130 is non-qualified ink, and when a difference between R1 and R2 is below the reference value, the determining unit 153 determines that the ink in the ink tank 130 is qualified ink.

When the determining unit 153 determines that the ink in the ink tank is qualified ink, the maintenance mode selecting unit 155 controls the printhead 120, the wiper 140, and the platen 145 according to a mode for qualified ink. Alternatively, when the determining unit 153 determines that the ink tank contains non-qualified ink, the maintenance mode selecting unit 155 controls the printhead 120, the wiper 140, and the platen 145 according to a mode for non-qualified ink.

Referring to FIG. 4, during wiping, the platen 145 moves downward away from the nozzle surface 122, and the cleaning member 143 of the wiper 140 wipes off the nozzle chips 124 and the nozzle surface 122 to remove ink drops D while the wiper 140 is sliding below the nozzle surface 122 in a direction indicated by the arrow. Further, while the wiper 140 is sliding out from beneath the nozzle surface 122 in the opposite direction of the arrow, the cleaning member 143 wipes off the nozzle surface 122.

Referring to FIG. 5, during spitting, the platen 145 moves downward, and while the tray 141 of the wiper 140 covers the nozzle surface 122, a small amount of ink is ejected from the nozzles 125.

As described above, non-qualified ink is thinner and dries faster than qualified ink. Thus, if the ink tank is refilled with non-qualified ink, spitting is preferably performed more frequently, a larger amount of ink is preferably ejected during a single spitting. Also wiping is preferably performed more frequently, compared with the case where the ink tank is refilled with qualified ink.

Therefore, when selecting the maintenance mode for non-qualified ink, the maintenance mode selecting unit 155 controls the printhead 120, the wiper 140, and the platen 145 such that the spitting cycle is shortened, a larger amount of ink is ejected during a single spitting and the wiping cycle is also shortened compared with the maintenance mode for qualified ink.

According to another exemplary embodiment of the present invention, the ID information stored in the ID memory 134 is a certification code from the manufacturer that authenticates the refilled ink as qualified ink. The ink tank 130 in which the ink is exhausted is replaced by a new ink tank refilled with ink, but the user cannot directly refill the empty ink tank 130 with ink. A non-qualified ink tank filled with non-qualified ink may not have the ID memory 134, or, if it does, the proper certification code is not stored in the ID memory 134. Hence, when the user installs a non-qualified ink tank in the printhead 120 and turns on the power supply, the controller 150 determines that the ink stored in the ink tank is non-qualified ink because the controller 150 does not receive the correct certification code. Thus, the controller controls the printhead 120, the wiper 140, and the platen 145 such that the maintenance is performed according to the maintenance mode for non-qualified ink.

According to the present invention, an inkjet image forming apparatus determines whether or not ink is qualified and performs maintenance operations according to the result of the determination. Thus, even when the apparatus is refilled with non-qualified ink, the print quality and life span of the inkjet image forming apparatus is similar to when the apparatus is refilled with qualified ink.

Additionally, a user can use inexpensive non-qualified ink for the inkjet image forming apparatus, which is more economical than qualified ink.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An inkjet printhead comprising:
an ink tank for storing ink;
a plurality of nozzles for forming an image on a printing medium by ejecting the ink stored in the ink tank to the printing medium; and
a memory for storing identity information for determining whether the ink stored in the ink tank is qualified ink or not.

2. The inkjet printhead of claim 1, wherein
the identity information stored in the memory is a certification code of a printer manufacturer, and
the memory is attached to the ink tank such that the memory is replaced by a new one when the ink tank is replaced.

3. The inkjet printhead of claim 1, further comprising:
a sensor for measuring an amount of ink remaining in the ink tank.

4. The inkjet printhead of claim 3, wherein
the identity information stored in the memory is set to an initial value each time that ink is refilled and is a dot count number obtained by counting a total number of ink dots ejected from the nozzles.

5. The inkjet printhead of claim 1, wherein
the inkjet printhead is an array type printhead.

6. An inkjet image forming apparatus comprising:
an inkjet printhead for forming an image on a printing medium by ejecting ink onto the printing medium; and
a controller for controlling an operation of the inkjet printhead,
wherein the inkjet printhead comprises:
an ink tank for storing ink;
a plurality of nozzles for forming an image on the printing medium by ejecting ink stored in the ink tank to the printing medium; and
a memory for storing identity information for determining whether the ink stored in the ink tank is a qualified ink or not, and
wherein the controller determines whether the ink stored in the ink tank is qualified ink based on the identity information and controls the printhead to perform maintenance operations according to a mode for qualified ink or non-qualified ink based on the determined result.

7. The inkjet printhead of claim 6, wherein
the inkjet printhead is an array type printhead.

8. The inkjet image forming apparatus of claim 6, wherein
the identity information stored in the memory is a certification code of a printer manufacturer,
the memory is attached to the ink tank such that the memory is replaced by a new one when the ink tank replaced, and
the controller determines that the ink stored in the ink tank is a non-qualified ink when the identity information stored in the memory is not a proper certification code.

9. The inkjet image forming apparatus of claim 6, wherein
the inkjet printhead further comprises a sensor for measuring an amount of ink remaining in the ink tank.

10. The inkjet image forming apparatus of claim 9, wherein
the identity information stored in the memory is set to an initial value each time when ink is refilled and is a dot count number obtained by counting a total number of ink dots ejected from the nozzles, and
the controller compares the amount of remaining ink calculated based on a signal of the sensor with the amount of remaining ink calculated based on the dot count number stored in the memory and determines that the ink stored in the ink tank is a non-qualified ink when a difference between the calculated amounts of remaining ink is greater than a predetermined reference value.

11. The inkjet image forming apparatus of claim 6, wherein
the maintenance operations include spitting a small amount of ink from the nozzles during a standby time, and
the controller controls the inkjet printhead such that a spitting cycle according to the mode for the non qualified ink is shorter than a spitting cycle according to the mode for qualified ink.

12. The inkjet image forming apparatus of claim 6, wherein
the maintenance operations include spitting a small amount of ink from the nozzles during a standby time, and
the controller controls the array type printhead such that an amount of ink ejected during a single spitting according to the mode for non-qualified ink is larger than according to the mode for qualified ink.

13. The inkjet image forming apparatus of claim 6, wherein
the maintenance operations include wiping ink drops around the nozzles during a standby time, and
the controller controls the array type printhead such that a wiping cycle according to the mode for non-qualified ink is shorter than a wiping cycle according to the mode for qualified ink.

14. A method for performing maintenance operations in an inkjet image forming apparatus, the method comprising:
determining whether or not ink stored in an ink tank is a qualified ink based on identity information stored in a memory formed on an inkjet printhead; and
selecting a maintenance mode and performing the maintenance operations according to a mode for qualified ink when the ink stored in the ink tank is determined as qualified ink or according to a mode for non-qualified ink when the ink stored in the ink tank is determined as non-qualified ink.

15. The method of claim 14, wherein
the identity information stored in the memory is a certification code of a printer manufacturer, and
in the step of determining whether or not ink stored in an ink tank is a qualified ink, the ink stored in the ink tank is determined as being non-qualified ink when the identity information stored in the memory is not a proper certification code.

16. The method of claim 14, wherein
the identity information is set to an initial value each time when the ink is refilled and is a dot count number obtained by counting the total number of ink dots ejected from the nozzles, and
in the in the step of determining whether or not ink stored in an ink tank is a qualified ink, an amount of remaining ink calculated based on a signal of a sensor that is for measuring an amount of remaining ink and is formed on an array type printhead and an amount of remaining ink calculated based on the dot count number stored in the memory are compared and when a difference between the calculated amounts of remaining ink is greater than a predetermined reference value, the ink stored in the ink tank is determined as being non-qualified ink.

17. The method of claim 14, wherein
in the step of selecting the maintenance mode and performing the maintenance operations, the maintenance operations include spitting a small amount of ink from the nozzles during a standby time, and the spitting is performed such that a spitting cycle according to the mode for the non qualified ink is shorter than a spitting cycle according to the mode for qualified ink.

18. The method of claim 14, wherein
in the step of selecting the maintenance mode and performing the maintenance operations, the maintenance operations include spitting a small amount of ink from the nozzles during a standby time, and the spitting is performed such that an amount of ink ejected during a single spitting according to the mode for non-qualified ink is larger than according to the mode for qualified ink.

19. The method of claim 14, wherein
in the step of selecting the maintenance mode and performing the maintenance operations, the maintenance operations include wiping ink drops around the nozzles during a standby time, and the wiping is performed such that a wiping cycle according to the mode for non-qualified ink is shorter than a wiping cycle according to the mode for qualified ink.

20. The method of claim 14, wherein
the inkjet printhead is an array type printhead.
